(19) United States
(12) Patent Application Publication
(10) Pub. No.: US 2011/0052848 A1
(43) Pub. Date: Mar. 3, 2011

(54) SALT RESISTANT POLYAMIDE COMPOSITIONS

(75) Inventors: SHAILESH RATILAL DOSHI, KINGSTON (CA); MARVIN M. MARTENS, BETTENDORF, IA (US); ANNAKUTTY MATHEW, KINGSTON (CA); STEVEN A. MESTEMACHER, PARKERSBURG, WV (US)

(73) Assignee: E.I. DU PONT DE NEMOURS AND COMPANY, Wilmington, DE (US)

(21) Appl. No.: 12/873,826

(22) Filed: Sep. 1, 2010

Related U.S. Application Data
(63) Continuation-in-part of application No. 12/720,941, filed on Mar. 10, 2010.
(60) Provisional application No. 61/159,204, filed on Mar. 11, 2009.

(51) Int. Cl. C08L 77/06; C08G 69/26; B32B 1/08

(52) U.S. Cl. 428/36.9; 528/339; 524/607

(57) ABSTRACT

Polyamides made from 1,6-hexanediamine, and the dicarboxylic acids 1,10-decandioic acid, 1,12-dodecanedioic acid, or 1,14-tetradecanedioic acid and terephthalic acid in specified proportions are particularly resistant to salt stressed (induced) corrosion cracking. This makes them particularly useful as vehicular parts which may be exposed to salts. Particularly when these polyamides contain tougheners and/or plasticizers they are especially useful for hoses and tubes.

### CROSS REFERENCE TO RELATED APPLICATIONS

This application is a continuation in part of application Ser. No. 12/720,941, filed Mar. 10, 2010, which claims the benefit of U.S. Provisional Application No. 61/159,204, filed Mar. 11, 2009, which is incorporated herein by reference in its entirety.

### FIELD OF THE INVENTION

Polyamides made from 1,12-dodecanedioic acid, 1,10-decanedioic acid, or 1,14-tetradecanedioic acid and terephthalic acid and 1,6-hexanediamine, and containing a certain ratio of the two diacids, have excellent resistance to stress cracking caused by salts.

### TECHNICAL BACKGROUND

Polymeric materials, including thermoplastics and thermosets, are used extensively in automotive vehicles and for other purposes. They are light and relatively easy to fashion into complex parts, and are therefore preferred instead of metals in many instances. However a problem with some metal alloys and some polymers is salt stress (induced) corrosion cracking (SSCC), where a part under stress undergoes accelerated corrosion when under stress and in contact with inorganic salts. This often results in cracking and premature failure of the part.

Polyamides such as polyamide 6,6, polyamide 6, polyamide 6,10 and polyamide 6,12 have been made into and used as vehicular parts and other types of parts. While it has been reported that polyamides 6,10 and 6,12 are more resistant to SSCC (see for instance Japanese Patent 3271325B2), all of these polyamides are prone to SSCC in such uses, because for instance, various sections of vehicles and their components are sometimes exposed to salts, for example salts such as sodium chloride or calcium chloride used to melt snow and ice in colder climates. Corrosion of metallic parts such as fittings and frame components made from steel and various iron based alloys in contact with water and road salts can also lead to formation of salts. These salts, in turn, can attack the polyamide parts making them susceptible to SSCC. Thus polyamide compositions with better resistance to SSCC are desired.

The use of polyamides in which they may be exposed to salts and thus undergo SSCC has been noted, see for instance Japanese Patents 327132582 and 3085540B2. Neither of these documents mentions the specific polyamides described here.

### SUMMARY OF THE INVENTION

This invention concerns, a vehicular part, comprising a composition, comprising, a polyamide whose repeat units consist essentially of about 68 to about 82 molar percent of repeat units of the formula

—C(O)(CH₂)ₘC(O)NH(CH₂)₆NH— (I)

wherein m is 8 and/or 10, and about 18 to about 32 molar percent of repeat units of the formula

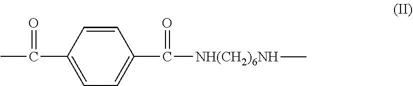

and provided that in normal operation said vehicular part is exposed to salt.

This invention also concerns a vehicle, comprising a part, comprising a composition comprising, a polyamide whose repeat units consist essentially of about 65 to about 85 molar percent of repeat units of the formula

—C(O)(CH₂)ₘC(O)NH(CH₂)₆NH— (I)

wherein m is 8 and/or 10, and about 15 to about 35 molar percent of repeat units of the formula

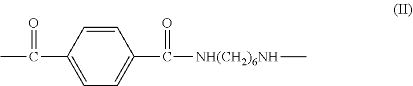

and provided that in normal operation said vehicular part is exposed to salt.

Also described herein is a polyamide, whose repeat units consist essentially of about 68 to about 82 molar percent of repeat units of the formula

—C(O)(CH₂)ₘC(O)NH(CH₂)₆NH— (I)

wherein m is 8 and/or 10, and about 18 to about 32 molar percent of repeat units of the formula

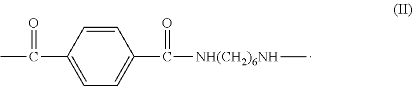

Further disclosed is a polyamide composition comprising a semi-aromatic copolyamide consisting essentially of about 68 to about 92 molar percent of repeat units of the formula

—C(O)(CH₂)ₘC(O)NH(CH₂)₆NH— (I)

wherein m is 12, and about 8 to about 32 molar percent of repeat units of the formula

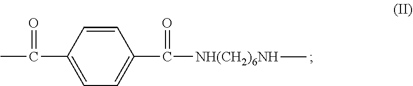

and a vehicular part, comprising a composition.

### DETAILS OF THE INVENTION

The compositions and vehicular parts of the instant invention offer improved resistance to degradation due to exposure to salt. Such exposure may be typically encountered, for instance, by parts that come into contact with road salt or salt in and around oceans and other bodies of water. In normal operation in these environments vehicular parts, particularly those used in under-the-hood applications, are vulnerable to degradation over prolonged periods of time. Even intermittent exposure to salt over time can have adverse effects.

By a “vehicle” is meant any device which moves which is on wheels and transports people and/or freight or performs other functions. The vehicle may be self propelled or not. Applicable vehicles include automobiles, motorcycles, wheeled construction vehicles, farm or lawn tractors, trucks, and trailers. Preferred vehicles are automobiles, trucks, and motorcycles.

By “in normal operation said part is exposed to salt” is meant that when tested in a normal vehicle configuration (as supplied by the manufacturer with all OEM guards in place, but no additional equipment present), the part is wet or otherwise exposed to a water solution on its exposed side in the following test. The vehicle is driven (or towed if not self propelling) at 50 km/h (˜30 mph) for 20 meters through a trough (so that all wheels go through the water or water solution) filled with water or a solution of a “marker” in water which is 1.5 cm deep. The part being tested is then checked to see if it is wet on the exposed side. If the part is wet it is considered exposed to salt in normal operation. If the part is normally hot in operation and the water would evaporate quickly, a marker substance is used in the water and part checked for the marker. The marker may be a salt (a white salt deposit will remain) of a chemical such as fluorescein which can be checked for using ultraviolet light. If the marker chemical is on the part, the part is considered as exposed to salt in normal operation. This test simulates moving on a highway that may be covered with salt particles that is melting ice or snow and/or a salt solution, and the resulting saltwater spray which is thrown onto the vehicle.

Repeat unit (I) of the polyamide is derived from 1,6-hexanediamine and 1,10-decanedioic acid (DDA) and/or 1,12-dodecanedioic acid (DDDA). Preferably either DDA or DDDA is present but not both. Repeat unit (II) of the polyamide is derived from 1,6-hexandiamine (NMDA) and terephthalic acid (T). The minimum amount of repeat unit (I) present is about 68 mole percent, preferably about 70 mole percent. The maximum amount of repeat unit (I) present is 82 mole percent, preferably about 80 mole percent. The remainder of the repeat units are repeat units (II). It is to be understood that any maximum amount of any repeat unit may be combined with any minimum amount of any repeat unit to form a preferred repeat unit range. Mole percents are based on the total amount of repeat units in the polyamide. The polyamide can be made by methods well known in the art for making polyamides, see for instance U.S. Pat. Nos. 5,891,987 and 6,656,589, and Japanese Patent Application 04239531, all of which are hereby included by reference, and the Examples herein.

In another embodiment repeat unit (I) of the polyamide is derived from 1,6-hexanediamine and 1,14-tetradecanedioic acid (TDDA) and repeat unit (II) of the polyamide is derived from 1,6-hexandiamine (NMDA) and terephthalic acid (T). The amount of repeat unit (I) present is about 68 to about 92 molar percent, preferably about 75 to about 92 molar percent.

The amount of repeat unit (II) present is 8 to about 32 molar percent and preferably about 8 to 25 molar percent.

A preferred polyamide, polyamide for a vehicular part is wherein said repeat units consist essentially of about 68 to 82 molar percent formula (I) and 18 to 32 molar percent of formula (II).

The polyamide may contain other substances normally found in polyamide compositions such as fillers and reinforcing agents, dyes, pigments, stabilizers, antioxidants, nucleating agents, flame retardants, polymeric tougheners, plasticizers, lubricants and mold release agents. Useful fillers and reinforcing agents include inorganic minerals such as clay, talc, wollastonite, and mica, and other materials such as glass fiber, glass flake, milled glass fiber, aramid fiber, carbon fiber, and carbon black. Preferred fillers/reinforcing agents are glass fiber and inorganic mineral fillers. These polyamide compositions may be made by conventional means such as melt mixing (the polyamide is melted) in a single or twin screw extruder. Parts may be formed from the polyamide (composition) by any method usually used for thermoplastics, such as injection molding, extrusion, compression molding, thermoforming, and rotational molding.

Preferred types of other substances are stabilizers, colorants, polymeric tougheners and plasticizers. By a polymeric toughener is usually meant a polymer which is an elastomer or has a lower melting point than the polyamide, and usually contains a large amount of amorphous polymer which at room temperature is above its glass transition temperature. The polymeric toughener may optionally have functional groups attached to it (“attachment” is usually by copolymerizing a functional monomer and/or grafted onto the toughener polymer) which often can react with group, such as end groups and amide groups, on the polyamide. Useful tougheners include polyolefins such as polyethylene, and polypropylene, ethylene copolymers such as a copolymer with propylene (EP rubber) and optionally a diene (EPDM rubber), higher olefins such as 1-butene, 1-hexene and/or 1-octene, copolymers of ethylene with alkyl (meth)acrylates (meaning esters of acrylic or methacrylic acids) and/or functionalized (meth)acrylate ester such as glycidyl (meth)acrylate. Also such polymer (especially those not containing an active functional group) grafted with an agent containing a functional group. Such grafting agents include maleic anhydride, maleic acid, maleic acid monoethyl ester, metal salts of maleic acid monoethyl ester, fumaric acid, fumaric acid monoethyl ester, itaconic acid, vinyl benzoic acid, vinyl phthalic acid, metal salts of fumaric acid monoethyl ester, monoesters of maleic or fumaric acid or itaconic acids where the alcohol is methyl, propyl, isopropyl, butyl, isobutyl, hexyl, cyclohexyl, octyl, 2-ethyl hexyl, decyl, stearyl, methoxy ethyl, ethoxy ethyl, hydroxy or ethyl, and the like. Preferably the amount of toughener present is about 5 to about 45% by weight of the entire composition, more preferably about 10 to about 40% by weight. More than one toughener polymer may be used, and the amount of toughener is taken as the total amount of all such polymers.

Another preferred substance in the composition is a plasticizer. A preferred amount of plasticizer is about 1.0 to about 20 weight percent, more preferably about 5 to about 15 weight percent, based on the total weight of the composition. In some compositions, especially tubes and hoses, it may be preferred that both plasticizer and polymeric toughener be present, preferably in the amounts already described.

Useful vehicular parts include cooling system components, intake manifolds, oil pans, transmission cases, electrical and electronic housings, fuel system components, filter housings, coolant pump covers, and radiator end tanks, provided of course that the particular part is exposed to salt in normal vehicle operation. A particularly useful part is fluid (liquid and/or gas) tubing or hose, used to transfer fluid from one portion of the vehicle to another. These polyamide compositions have properties that make them especially useful for tubes and hoses, for example one or more of good resistance to heat, the various fluids found in vehicles especially fuel, hydraulic fluid, and cooling fluid, flexibility (especially when containing plasticizers) and good high pressure burst resistance.

Another embodiment is a vehicular part, comprising a composition, comprising, a polyamide whose repeat units consist essentially of about 68 to about 92 molar percent of repeat units of the formula

—C(O)(CH₂)ₘC(O)NH(CH₂)₆NH— (I)

wherein m is 12, and about 8 to about 32 molar percent of repeat units of the formula

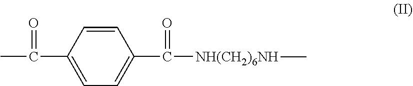

and provided that in normal operation said vehicular part is exposed to salt.

The present invention is further illustrated by the following examples. It should be understood that the following examples are for illustration purposes only, and are not used to limit the present invention thereto.

### Methods

Melting Points: In the Examples melting points are measured using ASTM Method ASTM D3418 at a heating rate of 10° C./min. On the second heat the melting point is taken as the peak of the melting endotherm.

SSCC Testing: ASTM D1693, Condition A, provides a test method for determination of environmental stress-cracking of ethylene plastics in presence of surface active agents such as soaps, oils, detergents etc. This procedure was adapted for determining stress cracking resistance of the copolyamides to SSCC as follows.

Rectangular test pieces measuring 37.5 mm×12 mm×3.2 mm were molded from the polyamide. A controlled nick was cut into the face of each molded bar as per the standard procedure, the bars were bent into U-shape with the nick facing outward, and positioned into brass specimen holders as per the standard procedure. At least five bars were used for each copolymer. The holders were positioned into large test tubes.

The test fluid used was 50% zinc chloride solution prepared by dissolving anhydrous zinc chloride into water in 50:50 weight ratio. The test tubes containing specimen holders were filled with freshly prepared salt solution fully immersing the test pieces such that there was at least 12 mm of fluid above the top test piece. The test tubes were positioned upright in a circulating air oven maintained at 50° C. Test pieces were periodically examined for development of cracks over a period of 24 hours, and in some cases up to 192 hours.

Physical Properties Measurement

The Polyamide compositions were injection molded into test bars. The tensile and flexural properties were measured as per ASTM D638 and ASTM D790 test procedures, respectively. Tensile strength was measured using 115 mm (4.5 in) long and 3.2 mm (0.13 in) thick type IV tensile bars per ASTM D638-02a test procedure with a crosshead speed of 50 mm/min (2 in/min).

Storage Modulus Storage modulus was determined with DMA measurements on injection molded izod bars of the following dimensions: 50 mm×12 mm×3.2 mm. DMA measurements were made using a TA Instruments model DMA Q800 in single canti-lever mode with 20 micrometer amplitude, 1 Hz frequency and heating rate of 2° C./min from −140 to 150° C. Storage module at 23° C. (E′₂₃) and 125° C. (E′₁₂₅) was determined, and the ratio E′₁₂₅/E′₂₃×100% gave the retention of storage modulus.

### Materials

In all the Examples all of the polyamide compositions contained 0.4% by weight of a stabilizer which was 7 parts (by weight) KI, 1 part CuI, and 1 part aluminum distearate.

In the Examples all pressures are gauge pressures unless otherwise noted.

Herein the following abbreviations are used:

PA612—Repeat unit (I) wherein m is 10.

PA610—Repeat unit (I) in which m is 8.

PA614—Repeat unit (1) wherein m is 12.

PA6T—Repeat unit (II).

PA66—A polyamide with a repeat unit derived from 1,6-hexanediamine and adipic acid.

In the Examples and Comparative Examples all tests are conducted at 23° C. and 50% relative humidity unless otherwise noted.

### Preparations of Polyamides

PA610 refers to Zytel® ZYTFE310064 polyamide 610 made from 1,6-diaminohexane and 1,10-decanedioic acid available from E. I. du Pont de Nemours and Company, Wilmington, Del., USA.

PA612 is Zytel® 158 NC010 resin, having a melting point of about 218° C., available from E. I. du Pont de Nemours and Company, Wilmington, Del.

PA612/6T copolyamides with 5, 13, 20, 25, 30 and 35 mole %

PA6T units, PA610/6T copolyamides with 5, 20, 25 and 30 mole % PA6T units and PA66/6T copolyamides with 20 and 25 mole % PA6T units were prepared in autoclaves as follows. Two sizes of autoclaves were employed, a small autoclave with 5 kg nominal capacity and a large autoclave with 50 kg nominal capacity. PA612 based copolyamides were prepared in both autoclaves, PA610 based copolyamides were made in the smaller autoclave and PA66 based copolyamides were prepared in the larger autoclave.

The procedure for making PA 610/6T 80/20 copolyamide in the smaller autoclave was as follows.

Salt Preparation: The autoclave was charged with DDA (2027.5 g), terephthalic acid (416.3 g), an aqueous solution containing 80.5 weight percent of HMDA (1832.7 g), an aqueous solution containing 1 weight percent sodium hypophosphite (34.5 g), an aqueous solution containing 28 weight percent acetic acid (51.7 g), an aqueous solution containing 1 weight percent Carbowax 8000 (10.3 g), and water (2223.5 g).

Process Conditions: The autoclave agitator was set to 5 rpm and the contents were purged with nitrogen at 69 kPa (10 psi) for 10 min. The agitator was set to 50 rpm, the pressure control valve was set to 1.72 MPa (250 psi), and the autoclave was heated to 275° C. The pressure reached 1.72 MPa within 45 min and was held there for another 90 min until the temperature of the clave had reached 245° C. The pressure was then reduced to 0 Pa over about 60 min. During this time, the temperature of the clave rose to 260° C. The autoclave pressure was reduced to 34.5 kPa (absolute) (5 psia) by applying vacuum and held there for 15 min. The autoclave was then pressurized with 480 kPa (70 psi) nitrogen and the molten polymer was cast from the autoclave. The collected polymer strands were quenched with cold water and pelletized.

The copolyamide obtained had an inherent viscosity (IV) of 1.06 dl/g; in this case, IV was measured on a 0.5% solution in m-cresol at 25° C.

For making other PA610 based copolyamide compositions, the quantities of DDA and terephthalic acid were adjusted to achieve the desired molar ratios. Similarly for making PA 612 based copolyamide, DDDA was used instead of DDA, and quantities of this acid and terephthalic acid were adjusted to achieve the desired molar ratios.

The procedure for making PA 612/6T copolyamides in the larger autoclave was as follows.

One hundred one kg (222 lbs.) of a 45 percent by weight of polyamide salt solution was prepared from HMDA, DDDA, and water, where the molar ratio of DDDA to T was adjusted to correspond to target PA6T content in the final polymer of 20, 25, 30 or 35 mole % 6T. The solution was charged into an autoclave with 3.4 g of a 10 percent by weight solution of a conventional antifoam agent in water, 0.7 g of sodium hypophosphite, between 146 to 322 g of 100% HMDA, and between 103 to 237 g of glacial acetic acid to get to the target pH of the salt solution of 8.1+/-0.1. The solution was then heated while the pressure was allowed to rise to 1.72 MPa (250 psi) at which point steam was vented to maintain the pressure at 1.72 MPa and heating was continued until the temperature of the batch reached 240° C. The pressure was then reduced slowly to reach in the range of 28-55 kPa (absolute) (4-8 psia), while the batch temperature was allowed to further rise to 265-275° C. The pressure was then held around 41 kPa (absolute) (6 psia) and the temperature was held at 265-275° C. for about 20 min. Finally, the polymer melt was extruded into strands, cooled, and cut into pellets. The copolyamides had an IV in the range of 0.87 to 1.02.

In order to make PA66/6T copolyamides, salt solution was prepared from HMDA, adipic acid and T, where the molar ratio of adipic acid to terephthalic acid was adjusted to correspond to target 6T content in the final polymer.

The procedure for making PA 614 polyamide was as follows:

Salt Preparation: A 10 L autoclave was charged with tetradecanedioic acid (2690 g), an aqueous solution containing 77 weight % of hexamethylene diamine (HMD) (1581 g), an aqueous solution containing 28 weight percent acetic acid (30 g), an aqueous solution containing 1 weight percent sodium hypophosphite (35 g), an aqueous solution containing 1 weight percent Carbowax 8000 (10 g), and water (2230 g).

Process Conditions: The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 240° C. The pressure was then reduced to 0 psig over about 45 minutes. During this time, the temperature of the contents rose to 260° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

The polyamide obtained had an inherent viscosity (IV) of 1.07 dl/g. The polymer had a melting point of 212° C., as measured by differential scanning calorimetry (DSC).

### Examples 1-6 and Comparative Examples A-H

Selected properties of these polyamides are shown in Table 1. In Table 1 the diamine used in all of the polyamides was 1,6-hexanediamne. Compositions show the mole percentages of dicarboxylic acids (as a total of the dicarboxylic acids present), 12=1,12-dodecanedioic acid, T=terephthalic acid, and 10=1,10-decanedioic acid. In Table 1 “Tm” is melting point determined by Differential Scanning calorimetry, ASTM D3418, heating rate 10° C./min, melting point taken at the maximum of the melting endotherm on the second heat.

TABLE 1

| | | | | | | Yield | Flexural |
|---|---|---|---|---|---|---|---|
| | Diacid, mole percent | | | | Tm | Stress | Modulus |
| Example | 10 | 12 | T | Adipic | (° C.) | MPa* | MPa* |
| A | 0 | 100 | 0 | 0 | 217 | 73 | 2100 |
| B | 0 | 95 | 5 | 0 | 211 | 71 | 2100 |
| C | 95 | 0 | 5 | 0 | 217 | 71.4 | 1783 |
| D | 0 | 0 | 20 | 80 | 265 | 84.7 | 2684 |
| E | 0 | 0 | 25 | 75 | 256 | 84.2 | 2668 |
| F | 100 | 0 | 0 | 0 | 223 | 62 | 2250 |
| G | 0 | 87 | 13 | 0 | 204 | 70.2 | 2145 |
| 1 | 0 | 80 | 20 | 0 | 200 | 64.2 | 1260 |
| 2 | 0 | 75 | 25 | 0 | 218 | 70.5 | 1920 |
| 3 | 0 | 70 | 30 | 0 | 219 | 75.6 | 2110 |
| H | 0 | 65 | 35 | 0 | 223 | 78.3 | 2250 |
| 4 | 80 | 0 | 20 | 0 | 205 | 61.7 | 1750 |
| 5 | 75 | 0 | 25 | 0 | 200 | 77.1 | 1966 |
| 6 | 70 | 0 | 30 | 0 | 197 | 75.7 | 2075 |

Per the above described procedure the polyamide were tested for SSCC in 50 weight percent ZnCl₂ solution and the results shown in Table 2. The designation X/Y means X number of pieces out of a total of Y pieces failed at this time. Designations of the polymers are the same as in Table 1. The data in Table 2 shows that comparative examples A to E, G and H perform very poorly in ZnCl₂ resistance test after 24 hours; whereas Examples 1-3 give unexpectedly excellent salt resistance. The excellent salt resistance is present at 162 hours treatment for Examples 1 and 3.

TABLE 2

| | Failures | | | | |
|---|---|---|---|---|---|
| | 1 | 6 | 18 | 24 | 162 |
| Example | hour | hours | hours | hours | hours |
| A | 0/6 | 6/6 | | | |
| B | 0/6 | 6/6 | | | |
| C | 4/6 | 6/6 | | | |
| D | 6/6 | | | | |
| E | 6/6 | | | | |
| G | 0/6 | 3/6 | | 6/6 | |
| 1 | 0/6 | 0/6 | 0/6 | 0/6 | 0/6 |
| 2 | 0/6 | 0/6 | 0/6 | 0/6 | |
| 3 | 0/6 | 0/6 | 0/6 | 0/6 | 0/6 |
| H | 0/5 | 0/5 | 3/5 | 5/5 | |
| 4 | 0/6 | 0/6 | 0/6 | 0/6 | |
| 5 | 0/5 | | 3/5 | 3/5 | |
| 6 | 0/5 | | | 2/5 | |

### Example 7

Polymers of Examples 2 and 3 were mixed with 10 weight percent n-butyl benzene sulfonamide (available commercially as Uniplex® 214). The resulting compositions were injection molded into test bars and tested for yield stress (ASTM D638) and Flexural modulus (ASTM D790). Yield stress was measured using 115 mm (4.5 in) long and 3.2 mm (0.13″) thick type IV tensile bars per ASTM D638-02a test procedure with a crosshead speed of 50 mm/min (2 in/min). Flexural modulus was measured using 3.2 mm (0.13 in) thick test pieces per ASTM D790 test procedure with a 50 mm (2 in) span, 5 mm (0.2 in) load and support nose radii and 1.3 mm/min (0.05 in/min) crosshead speed. Results are shown in Table 3.

These compositions were also extruded into tubes with an OD of 8.35 mm and an ID of 6.35 mm. The burst pressure of these tubes was measured at 23° C. and 136° C. using a manual hydraulic pump equipped with a pressure gauge. Results are also given in Table 3.

TABLE 3

| Polymer of Ex. | 2 | 3 |
|---|---|---|
| Yield stress, MPa | 32.9 | 32.4 |
| Flexural modulus, MPa | 528.1 | 596.4 |
| Burst Pressure 23° C., MPa | 7.9 | 6.2 |
| Burst pressure 136° C., MPa | 2.6 | 2.7 |

### Example 8

The polymers of Examples 1, 2 and 3 were mixed with 25 or 40 weight percent of a toughener which was mixed into the polyamide in a twin screw extruder (based on the total weight of the toughener and polyamide). The toughener consisted of 60 weight percent Exxon LL1002.09 linear low density polyethylene, 28 weight percent of a maleic anhydride grafted low density polyethylene (Fusabond® MB 226 D available from E. I. du Pont de Nemours and Company) and 12 weight percent of a maleic anhydride grafted EPDM (Nordel® IP 3745), available from Dow Elastomers). The compositions were molded into test bars and tested in the same manner as described in Example 7. Also in the same manner as in Example 7, the compositions were extruded in tubes and tested for burst pressure. Results are shown in Table 4.

TABLE 4

| | Weight Percent toughener | | | | | |
|---|---|---|---|---|---|---|
| | 25 | | | 40 | | |
| Polymer of Ex. | 1 | 2 | 3 | 2 | 2 | 3 |
| Yield stress, MPa | 38.1 | 42.0 | 42.5 | 30.2 | 31.0 | 31.8 |
| Flexural modulus, MPa | 942.5 | 1162.5 | 1161.1 | 747.4 | 777.0 | 838.4 |
| Burst Pressure 23° C., | 6.1 | 7.2 | 9.3 | 6.6 | 6.8 | 6.3 |
| MPa | | | | | | |
| Burst pressure 136° C., | 1.8 | 1.8 | 2.4 | 1.8 | 1.5 | 1.4 |
| MPa | | | | | | |

### Example 9

Polymers from Examples 1, 2 and 3 were mixed with 5.0 weight percent of the plasticizer from Example 7 and 22.8 weight percent of the toughener of Example 8. Test bars and hoses were prepared as in Examples 7 and 8, and tested in the same manner as in those Examples. Results are given in Table 5.

TABLE 5

| Polymer of Ex. | 1 | 2 | 3 |
|---|---|---|---|
| Yield stress, MPa | 23.1 | 26.7 | 27.7 |
| Flexural modulus, MPa | 548.8 | 654.3 | 588.5 |
| Burst Pressure 23° C., MPa | 6.5 | 6.3 | 6.4 |
| Burst pressure 136° C., MPa | 1.8 | 2.4 | 2.0 |

As shown in Examples 7-9, these polyamides, when mixed with tougheners and/or plasticizers typically exhibit excellent flexibility and good burst strength, as well as good salt stress cracking resistance, a good combination of properties for hoses and tubing, especially in an environment in which salts are present.

### Examples 10-12

The following procedure illustrates the formation of PA614/6T (90/10 molar ratio).

Salt Preparation: A 10 L autoclave was charged with tetradecanedioic acid (2482 g), terephthalic acid (177 g), an aqueous solution containing 77 weight % of hexamethylene diamine (HMD) (1621 g), an aqueous solution containing 28 weight percent acetic acid (15 g), an aqueous solution containing 1 weight percent sodium hypophosphite (35 g), an aqueous solution containing 1 weight percent Carbowax 8000 (10 g), and water (2220 g). The process conditions were the same as that described above for PA614.

The co-polyamide obtained had an inherent viscosity (IV) of 1.21 dl/g. The polymer had a melting point of 204° C., as measured by differential scanning calorimetry (DSC).

PA614/6T (80/20 molar ratio) and PA614/6T (70/30 molar ratio) compositions were prepared using the same procedure, as disclosed above, and adjusting the quantitative amount of tetradecanedioic acid and terephthalic acid to achieve the desired mole ratio.

Table 6 lists the compositions, physical test data and salt resistance for Examples 10-12 and Comparative Examples J, A and F.

The data in Table 6 shows that Comparative Examples A and F perform very poorly in ZnCl₂ resistance test after 4 hours; and comparative Example J has 4/5 failures at 21 hours. Examples 10-12 give unexpectedly good salt resistance with only 1/5 failures present at 212 hours treatment.

TABLE 6
Properties of 614/6T Copolyamides and comparative examples

| Example | 10 | 11 | 12 | J | A | F |
|---|---|---|---|---|---|---|
| Composition | PA614/6T | PA614/6T | PA614/6T | PA614 | PA612 | PA610 |
| (mole %) | 90/10 | 80/20 | 70/30 | | | |

DSC data

| | | | | | | |
|---|---|---|---|---|---|---|
| Melting point (° C.) | 204 | 193 | 191 | 212 | 218 | 224 |

DMA data

| | | | | | | |
|---|---|---|---|---|---|---|
| Storage modulus | 1428 | 1764 | 1503 | 1874 | 1988 | 1887 |
| @ 23° C., E′₂₃ | | | | | | |
| (MPa) | | | | | | |
| Storage modulus | 194 | 182 | 178 | 320 | 362 | 329 |
| @125° C., E′₁₂₅ | | | | | | |
| (MPa) | | | | | | |
| (E′₁₂₅/E′₂₃ × 100%) | 14 | 10 | 12 | 17 | 18 | 17 |

Physical Properties at 23° C. (DAM)

| | | | | | | |
|---|---|---|---|---|---|---|
| Tensile Strength | 64 | 57 | 59 | 59 | 67 | 63 |
| (MPa) | | | | | | |
| Elongation at Break | 33 | 229 | 43 | 43 | 37 | 194 |
| (%) | | | | | | |
| Tensile E-Modulus | 1823 | 1640 | 1736 | 1956 | 2153 | 1904 |
| (MPa) | | | | | | |

Salt Stress crack test in ZnCl₂ at 50° C. (Failures)

| | | | | | | |
|---|---|---|---|---|---|---|
| 0 hrs | 0/5 | 0/5 | 0/5 | 0/5 | 0/5 | 0/5 |
| 4 hrs | 0/5 | 0/5 | 0/5 | 0/5 | 5/5 | 5/5 |
| 21 hrs | 1/5 | 1/5 | 0/5 | 4/5 | 5/5 | 5/5 |
| 45 hrs | 1/5 | 1/5 | 1/5 | 4/5 | 5/5 | 5/5 |
| 165 hrs | 1/5 | 1/5 | 1/5 | 4/5 | 5/5 | 5/5 |
| 212 hrs | 1/5 | 1/5 | 1/5 | 5/5 | 5/5 | 5/5 |

What is claimed is:

1. A polyamide composition comprising a semi-aromatic copolyamide consisting essentially of about 68 to about 92 molar percent of repeat units of the formula
—C(O)(CH₂)ₘC(O)NH(CH₂)₆NH— (I)
wherein m is 12, and about 8 to about 32 molar percent of repeat units of the formula

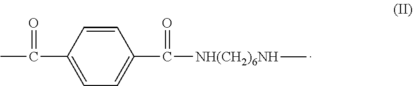

2. The polyamide composition as recited in claim 1 wherein said composition contains a toughener and/or a plasticizer.

3. The polyamide composition as recited in claim 2 wherein said toughener is present in an amount of toughener is about 5 to about 45 percent by weight of the composition.

4. The polyamide composition as recited in claim 2 wherein said plasticizer is about 1.0 to about 20 weight percent of the composition.

5. The polyamide composition as recited in claim 1 wherein said polyamide repeat units consist essentially of about 75 to 92 molar percent formula (I) and 8 to 25 molar percent of formula (II).

6. The polyamide composition as recited in any one of claims 1-4 which is a hose or tube.

7. A vehicular part, comprising a composition, comprising, a polyamide whose repeat units consist essentially of about 68 to about 92 molar percent of repeat units of the formula
—C(O)(CH₂)ₘC(O)NH(CH₂)₆NH— (I)
wherein m is 12, and about 8 to about 32 molar percent of repeat units of the formula 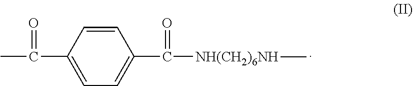
and provided that in normal operation said vehicular part is exposed to salt.
